(19) United States
(12) Patent Application Publication
(10) Pub. No.: US 2023/0233967 A1
(43) Pub. Date: Jul. 27, 2023

(54) AIR FILTRATION MATERIAL, FILTERS COMPRISING THE SAME AND METHOD FOR MANUFACTURING THE SAME

(71) Applicant: Korganotech Inc, Livermore, CA (US)

(72) Inventors: Deepak Upadhyaya, Fremont, CA (US); Mark Edward Leong, Danville, CA (US)

(21) Appl. No.: 18/099,920

(22) Filed: Jan. 21, 2023

Related U.S. Application Data
(60) Provisional application No. 63/302,024, filed on Jan. 21, 2022.

(51) Int. Cl. B01D 39/16; B01D 53/88; B01D 53/00; D04H 3/16; D04H 3/03; D04H 3/011; D04H 3/007; D01F 1/10; D01F 6/36; D01F 6/38

(52) U.S. Cl. CPC B01D 39/1623; B01D 53/885; B01D 53/007; D04H 3/16; D04H 3/03; D04H 3/011; D04H 3/007; D01F 1/10; D01F 6/36; D01F 6/38; B01D 2239/025; B01D 2239/0258; B01D 2239/0407; B01D 2239/0618; B01D 2239/0631; B01D 2239/0654; B01D 2239/10; B01D 2239/1291; B01D 2239/1258; B01D 2239/1233; B01D 2239/1225; B01D 2239/1241; B01D 2255/802; B01D 2259/804; B01D 2255/104; B01D 2255/20792; B01D 2255/9202; B01D 2255/20707; B01D 2255/20761; D10B 2321/10; D10B 2321/08; D10B 2505/04

(57) ABSTRACT

The present disclosure relates to a method for manufacturing an air filtration material, in which the porous metallic support is treated with at least one chemical agent to improve adherence of the electrospun nanofibers. The air filtration material obtained from such method comprises nanoparticle photocatalysts, wherein the nanoparticle photocatalysts are embedded in the electrospun nanofibers and part of the nanoparticle photocatalysts is exposed at the surface of the electrospun nanofibers through nanopores. An air filtration device, comprising the air filtration material, a UV LED and a power source. A method of using the air filtration material wherein an air flow passes through the air filtration material, wherein the air flow has a pollutant content before passing through the material, in order to decrease the air pollutant content. The nanoparticle photocatalysts inactivate or kill the pathogens when the device is in operation.

### CROSS-REFERENCES TO RELATED APPLICATIONS

This application claims priority to U.S. Provisional Application No. 63/302,024, filed on Jan. 21, 2022, which is incorporated in its entirety herein for all purposes.

### BACKGROUND OF THE INVENTION

Some pollutants in the air, including chemicals, gases and living organisms (like mold and pests), may be harmful in closed environments such as buildings, planes, trains, automobiles, or animal farms. As recognized by the U.S. Environmental Protection Agency, controlling common pollutants indoors, such as pollen, dust, mold, spores, bacteria, viruses, or volatile organic compounds (VOCs) (for example formaldehyde, cleansers, pesticides, fungicides, or any combustion exhausts), is critical to reduce risk of indoor health concerns.

Technologies based on Photocatalytic Oxidation (PCO) can be used for air purification. In institutional air handling systems incorporating PCO technologies, a UV light source reacts with a titanium dioxide (TiO₂)-based catalyst, in the presence of water, to create free hydroxyl radicals and super-oxide ions oxidizers that convert air pollutants, including microorganisms, chemicals, and volatile organic compounds (VOCs) (such as formaldehyde, cleansers, pesticides, fungicides, or any combustion exhausts), into CO₂ and H₂O.

Titanium dioxide (TiO₂) is frequently used as the photocatalyst in PCO air filtration systems, for the reasons that TiO₂ is inexpensive, readily available, non-toxic, chemically, and mechanically stable. Other photocatalysts may also be used including copper, stannic oxide, zinc oxide, vanadium oxide, dibismuth trioxide, tungsten trioxide, ferric oxide, strontium titanate, cadmium sulphide, zirconium oxide, antimony oxide, and cerium oxide.

Photocatalysts are incorporated in nano-size form into polymer nanowires and deposited onto substrates (e.g., copper nano-wire films, filter papers, textiles). Photocatalyst may be loaded with metals to improve efficiency.

Air filtration systems based on PCO may be prepared by a sol-gel processes, but these have many drawbacks. Conventional liquid coatings lead to streaks, non-uniform coating thickness, and have high incidence of chipping and flaking. Alternate processes are available, according to which the photocatalyst is mixed with resin to form a mixture which is then electrostatically charged and sprayed onto a substrate. These processes similarly have poor thickness control, lead to uneven distribution of the photocatalysts and surface of photocatalysts is usually covered with solution coating.

### BRIEF SUMMARY OF THE INVENTION

In one aspect, the present invention provides a method for manufacturing an air filtration material, comprising:
a) providing a porous metallic support, having a thickness of 15 to 100 μm;
b) treating the support with at least one chemical agent;
c) providing a polymeric solution comprising a (co)polymer, a solvent and nanoparticle photocatalysts; and
d) electrospinning the polymeric solution onto the support to generate a material with at least one layer of nonwoven electrospun nanofibers in contact with the support, wherein the nanoparticle photocatalysts are embedded in the electrospun nanofibers, wherein the electrospun nanofibers in the air filtration material have an average diameter (AFD) of about 30 to 300 nm and a length to diameter aspect ratio (DAR) of greater than 1000 to 1.

In another aspect, the present invention provides an air filtration material, comprising:
a porous metallic support which has been treated with at least one chemical agent, having a thickness of 15 to 100 μm;
at least one layer of nonwoven electrospun nanofibers in contact with the support, wherein the electrospun nanofibers have an average diameter (AFD) of about 30 to 300 nm and a length to diameter aspect ratio (DAR) of greater than 1000 to 1;
nanoparticle photocatalysts;
wherein the nanoparticle photocatalysts are embedded in the electrospun nanofibers, and part of such nanoparticle photocatalysts is exposed at the surface of the electrospun nanofibers through nanopores.

In another aspect, the present invention provides an air filtration device, comprising:
the air filtration material of the present invention;
a UV LED; and
a power source.

In another aspect, the present invention provides a method of using the air filtration material of the present invention, comprising:
a) passing an air flow through the air filtration material, wherein the air flow has a pollutant content before passing through the material, in order to decrease the air pollutant content; and
b) optionally washing the air filtration material for reuse.

### BRIEF DESCRIPTION OF THE DRAWINGS

FIG. 1 shows a scanning electron micrograph (SEM) of electrospun nanofibers with embedded/encapsulated zinc oxide nanoparticle photocatalysts.

FIG. 2 shows a scanning electron micrograph (SEM) of several agglomerated silver nanoparticles photocatalysts embedded/encapsulated in an electrospun porous nanofiber.

FIG. 3 shows a scanning electron micrograph (SEM) of the high porosity of a several agglomerated silver nanoparticles photocatalyst embedded/encapsulated in an electrospun nanofiber.

FIG. 4 shows a scanning electron micrograph (SEM) of the porous woven metallic copper support after chemical processing.

### DETAILED DESCRIPTION OF THE INVENTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. Also, in the following description, a same element may have different references in different figures.

Should the disclosure of any patents, patent applications, and publications which are incorporated herein by reference conflict with the description of the present application to the extent that it may render a term unclear, the present description shall take precedence.

In a first aspect, the present disclosure relates to a method for manufacturing an air filtration material, comprising at least the four following steps:
a) providing a porous metallic support, having a thickness of 15 to 100 μm;
b) treating the support with at least one chemical agent;
c) providing a polymeric solution comprising a (co)polymer, a solvent and nanoparticle photocatalysts;
d) electrospinning the polymeric solution onto the support to generate a material with at least one nonwoven layer of electrospun nanofibers in contact with the support, wherein the nanoparticle photocatalysts are embedded in the electrospun nanofibers, wherein the electrospun nanofibers in the air filtration material have an average diameter (AFD) of about 30 to 300 nm and a length to diameter aspect ratio (DAR) of greater than 1000 to 1.

The metallic support is porous, i.e., with void spaces in the material. Size, frequency, number, and/or interconnectivity of pores and voids contribute to the porosity of a support. In some embodiments, the support is expanded or perforated.

The term “porosity” in connection with the air filtration material refers to holes and spaces and the absence of material in the support, in which air may pass.

The porous metallic support is preferably arranged in a woven way.

The porous metallic support has a thickness which varies between 15 and 100 μm, for example between 20 and 90 μm, between 30 and 80 μm or between 40 and 70 μm.

In some embodiments, the support is at least partly made of at least one of copper, iron, aluminum and/or silver. The support may be made of one, two, three or four of these metals, which can be used in combination.

According to some embodiments, the support is fully made of at least one of copper, iron, aluminum and/or silver. According to such embodiments, the support may be fully made of one of copper, iron, aluminum or silver.

In some embodiments, the support is at least partly coated with at least one of copper, iron, aluminum and/or silver. According to such embodiments, the support may be fully coated with at least one of copper, iron, aluminum and/or silver. For example, the support may be fully coated with one of copper, iron, aluminum or silver.

According to step b) of the method of the present invention, the support is treated with at least one chemical agent. The treatment with the chemical agent not only increases the surface roughness (also called mechanical roughness) of the support in order to facilitate the attachment (or bonding) of the electrospun nanofibers during step d) but also increases the surface area to enhance photocatalytic activity.

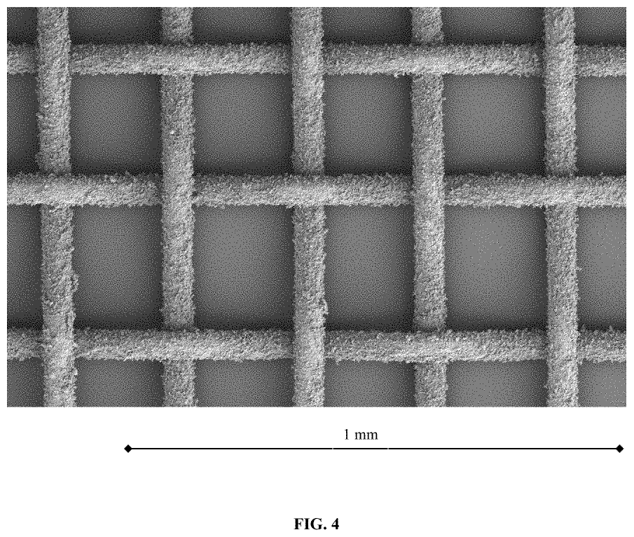

FIG. 4 shows a scanning electron micrograph (SEM) of the porous woven metallic support after step b). The woven copper support which was treated according to the method described in Example 1 is characterized by a surface roughness of 500-1000 nm and a higher surface area, in comparison to the same support before step b), which presented a surface roughness of 50 nm, wherein surface roughness is measured as per ASME B46.1.

In some preferred embodiments, the support is treated is treated in order to increase surface roughness and photocatalytic induced bioactivity of the support surface, when the material is in use.

The support may be cleaned before step b). For that purpose, acetone may for example be used, followed by a step of washing with, e.g., water.

The treatment of the support according to step b) may be in one step or in several steps. The support may optionally be washed after treatment or between treatment steps.

The chemical agent of step b) may be used alone or in combination with other components.

In some embodiments, the chemical agent comprises at least one of iron chloride, sodium hydroxide, ammonium persulfate and/or citric acid. The support may for example be treated with one of these chemicals or several of them. For example, two or three distinct chemical agents may be used for treating the support. They may be used as mixtures or sequentially, with optional intermediate and/or final washing (e.g., with deionized water).

In some embodiments, step b) consists in treating the support with one or several chemical agents selected from iron chloride, sodium hydroxide, ammonium persulfate and/or citric acid. For example, in these embodiments, step b) may consist in treating the support with a first chemical agent, then a step of washing with, for example, deionized water, then a step of treating the support with a second chemical agent, and then a final step of washing. According to another example, step b) may consist in treating the support with two chemical agents mixed together, then a step of washing.

In some other embodiments, step b) consists in treating the support with a formulation comprising at least one chemical agent, optionally combined with heat treatment, to create surface grown nanowires. The chemical agent may be used in combination with other components which may for example be selected to create surface grown metal nanowires on the porous metallic support. The formulation may comprise one or several of the chemical agents selected from iron chloride, sodium hydroxide, ammonium persulfate and/or citric acid, as well as acetone and water (e.g., deionized water).

Step b) may preferably take place at room temperature, but can possibly take place at a temperature varying between 25 and 100° C., for example between 30 and 90° C. or between 35 and 80° C.

In some embodiments, the support is treated with at least one chemical agent for at least 5 seconds (s), at least 10 s, at least 15 s, at least 20 s, at least 1 minute (min), at least 2 min, or at least 3 min. In some other embodiments, the support is treated with at least two distinct chemical agents, each treating step being for at least 5 s. In some other embodiments, the support is treated two times with the same chemical agent, each treating step being for at least 5 s.

In some exemplary embodiments, the support is treated as follows:
with at least one chemical agent for at least 5 s, then washed;
with at least one chemical agent for at least 5 s, then washed, then treated with the same chemical agent or a distinct one for at least 5 s, then washed; or
with one chemical selected from the group consisting of iron chloride, sodium hydroxide, ammonium persulfate and citric acid for at least 5 s, and then washed with water.

The polymeric solution used in step c) of the method of the present invention comprises a (co)polymer, a solvent and nanoparticle photocatalysts.

Such polymeric solution may be prepared by mixing the components all together in a vessel.

In some preferred embodiments, the nanoparticle photocatalysts are soaked in solvent prior to mixing with the (co)polymer. This step is advantageous to adsorb the solvent on the nanoparticle photocatalysts, as the evaporation of the solvent from particle surface during the electrospinning helps to create nanofiber porosity and therefore increase the specific surface area of the nanofibers.

The term “porosity” in connection with nanofibers refers to nanofibers presenting a surface morphology with pores. The pores may have different shapes, such as cylinders or ovals. The porosity of the nanofibers is an advantageous feature in the context of the present invention, as it allows direct contact of the nanoparticle photocatalysts with pollutants when the air filtration material is in use.

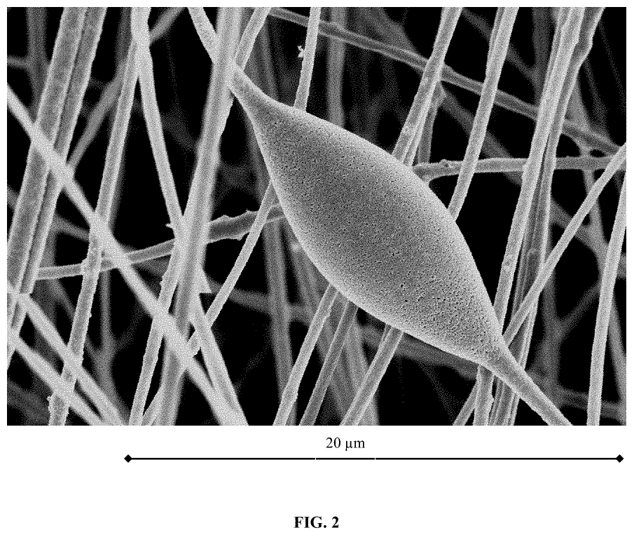

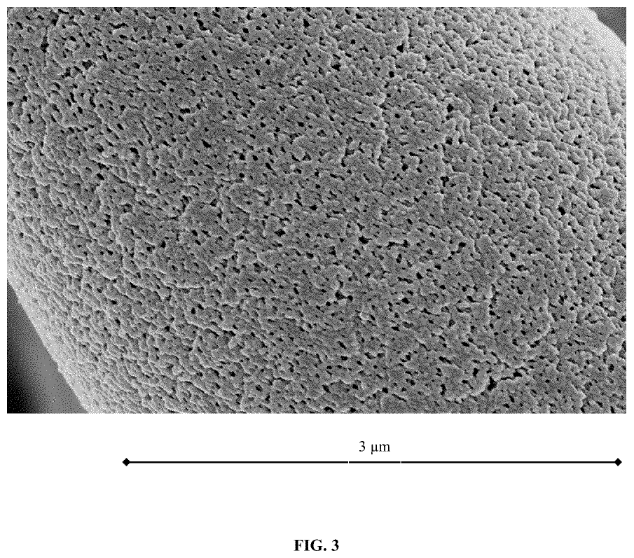

Reference can be made to FIGS. 2 and 3 which show the porosity of some electrospun nanofibers according to the present invention. FIG. 3 specifically shows the porosity of one encapsulated photocatalyst, which exposes it to pollutants when the filtration system is in operation, thereby significantly improving the performance of the filtration system to notably deactivate pathogens such as corona viruses, bacteria and bacteriophages.

Without wishing to be bound to a theory, it is believed that interaction of pathogens captured by air filtration systems of the present invention with metal ions created via dissolution of embedded nanoparticles within the porous electrospun nanofibers causes severe damage to the pathogen's protein and DNAs resulting in deactivation and neutralization of such pathogens. In some examples, the air filtration materials of the present invention have been shown to:
kill 99.95% of bovine Corona viruses (as a surrogate for the Human SAR Cov-2) within 10 minutes;
kill Klebsiella pneumonia (ATCC 4352) and Staphylococcus aureus (ATCC 6538) bacteria within 24 hours, based on ATCC 100 test protocol; and
capture ΦX174 bacteriophage at a 28.3 L/min flow rate based on ASTM F2101-19 test method.

In some embodiments, the (co)polymer comprises recurring units of at least one of poly-L-lactic acid (PLLA), polycaprolactone (PCL), polystyrene (PS), polyamide (PA), polysulfone, polyacrylic acid (PAA), polymethacrylic acid (PMA), polycarbonate (PC), cellulose acetate butyrate (CAB), glycol-modified polyethylene terephthalate (PETG), poly(methyl methacrylate) (PMMA) or polyacrylonitrile (PAN).

According to the present invention, the (co)polymer may be a homopolymer made exclusively of the same recurring units, or it can be a copolymer and comprise at least two distinct recurring units. When it is a copolymer, it may comprise a majority of one recurring unit, for example selected from the group consisting of PLLA, PCL, PS, PA, polysulfone, PAA, PMA, PC, CAB, PETG, PMMA and PAN, and one minority of another recurring unit. For example, the copolymer may comprise at least 50 mol. % of one recurring unit selected from the group consisting of PLLA, PCL, PS, PA, polysulfone, PAA, PMA, PC, CAB, PETG, PMMA and PAN, based on the total number of moles in the copolymer. In some embodiments, the copolymer comprises at least 60 mol. % of one recurring unit selected from the group consisting of PLLA, PCL, PS, PA, polysulfone, PAA, PMA, PC, CAB, PETG, PMMA and PAN, at least 70 mol. %, at least 80 mol. %, at least 90 mol. %, at least 95 mol. %, or at least 98 mol. % of one recurring unit selected from the group consisting of PLLA, PCL, PS, PA, polysulfone, PAA, PMA, PC, CAB, PETG, PMMA and PAN.

In some preferred embodiments, the solution comprises at least one homopolymer of poly-L-lactic acid (PLLA), polycaprolactone (PCL), polystyrene (PS), polyamide (PA), polysulfone, polyacrylic acid (PAA), polymethacrylic acid (PMA), polycarbonate (PC), cellulose acetate butyrate (CAB), glycol-modified polyethylene terephthalate (PETG), poly(methyl methacrylate) (PMMA) or polyacrylonitrile (PAN).

Most preferably, the (co)polymer comprises recurring units selected from the group consisting of PMMA and PAN. Even more preferably, the (co)polymer comprises recurring units from PAN.

In some embodiments, the polymeric solution comprises 1 to 80 wt. % of (co)polymer, based on the total weight of the polymeric solution. For example, the polymeric solution may comprise 5 to 70 wt. % of (co)polymer, 10 to 60 wt. %, or 15 to 50 wt. % of (co)polymer, based on the total weight of the polymeric solution.

In some embodiments, the solvent of the polymeric solution comprises at least one of water (e.g., deionized water), N,N-dimethylformamide (DMF), formic acid, dichloromethane, acetic acid, chlorophenol, hexafluoroisopropanol, or trifluoroacetic acid. Preferably, the solvent is DMF and/or deionized water.

In some embodiments, the polymeric solution comprises 1 to 20 wt. % of solvent, based on the total weight of the polymeric solution. For example, the polymeric solution may comprise 2 to 18 wt. % of solvent, 3 to 15 wt. %, or 4 to 12 wt. % of solvent, based on the total weight of the polymeric solution.

The air filtration material of the present invention comprises nanoparticle photocatalysts which are embedded in the electrospun nanofibers. Exposure of these photocatalysts at the surface of the nanofibers significantly improves the efficiency of the air filtration material described herein. The nanoparticle photocatalysts kill or deactivate the pathogens when they contact the filtration device in operation.

In some embodiments, the nanoparticle photocatalysts comprise at least one of titanium oxide, copper (oxide), stannic oxide, zinc oxide, vanadium oxide, dibismuth trioxide, tungsten trioxide, ferric oxide, strontium titanate, cadmium sulfide, zirconium oxide, antimony oxide, or cerium oxide.

Mixtures of nanoparticle photocatalysts may be used in the polymeric solution of the present invention. In some embodiments, the polymeric solution comprises at least two of the following nanoparticle photocatalysts: titanium oxide, copper (oxide), stannic oxide, zinc oxide, vanadium oxide, dibismuth trioxide, tungsten trioxide, ferric oxide, strontium titanate, cadmium sulfide, zirconium oxide, antimony oxide, and cerium oxide.

According to the present invention, the nanoparticle photocatalysts are preferably silver nanoparticles.

In some embodiments, the nanoparticle photocatalysts have an average size of 5 to 200 nm. The nanoparticle photocatalysts may for example have an average size of 10 to 180 nm, 20 to 150 nm, 30 to 130 nm or 40 to 110 nm. According to the present invention, the nanoparticle photocatalysts preferably have an average size of 15 nm.

In some embodiments, the polymeric solution comprises 1 to 70 wt. % of nanoparticle photocatalysts, based on the total weight of the polymeric solution. For example, the polymeric solution may comprise 2 to 60 wt. % of nanoparticle photocatalysts, 5 to 50 wt. %, or 10 to 40 wt. % of nanoparticle photocatalysts, based on the total weight of the polymeric solution.

In some embodiments, the polymeric solution comprises:
1 to 80 wt. % of (co)polymer;
1 to 20 wt. % of solvent; and
1 to 70 wt. % of nanoparticle photocatalysts,
based on the total weight of the polymeric solution.

In some preferred embodiments, the polymeric solution comprises:
10 to 60 wt. % of (co)polymer;
20 to 60 wt. % of solvent; and
10 to 45 wt. % of nanoparticle photocatalysts,
based on the total weight of the polymeric solution.

The polymer concentration in the polymeric solution is adjusted to the (co)polymer used to generate the nanofibers, including its composition and molecular weight.

In some embodiments, the polymeric solution further comprises at least one adhesive and/or at least one biocide. In some other embodiments, the polymeric solution is free of adhesive and/or biocide.

The optional adhesive may comprise methyl 2-cyanoacrylate.

According to step d) of the method of the present invention, the polymeric solution is electrospun onto the support.

The electrospinning of the polymeric solution onto the support is performed with a device which includes an electrospinning element configured to electrospin a plurality of nanofibers from a tip of the dispensing reservoir (electrically insulated), a collector opposed to the electrospinning element configured to collect electrospun nanofibers on a surface of the support, and an electric field modulation device configured to abruptly vary an electric field at the collector at least once during electrospinning of the nanofibers.

The electrospinning technique is described in the state of the art. In short, a hollow orifice in the dispensing reservoir is connected to a high-voltage power supply that is controlled at a constant voltage. The voltage gradient pulls the polymeric solution from the orifice (also called spinneret) into a fluid filament. The charged polymer jet is collected on the support which is attached to the grounded collector. As the polymer solution dries, charges on the surface of the polymer repel each other, stretching the fibers and causing a whipping motion resulting in a significant reduction in fiber diameter. The nanofibers are collected onto the support which is connected to a grounded electrode surface.

In some embodiments, a rapidly rotating drum (electrically ground state) is used as a ground. It is also moving laterally along the rotating axis and collects randomly oriented fibers on variety of substrates.

In some embodiments, the length of the hollow orifice in the dispensing reservoir ranges from 10 mm to 45 mm, with a preferred length of 25 mm.

The electrospun nanofibers have been shown to better adhere to the support, when the support is treated according to step b) (i.e., chemical etching). This is one of the essential features of the invention.

At least one nonwoven layer of nanofibers is electrospun onto the support, to be in contact with the support. One layer or several layers of nanofibers may be electrospun onto the support according to step d). Preferably, several layers of nanofibers are electrospun onto the support, for example at least 10 layers, at least 15 layers, at least 20 layers or at least 25 layers.

The term “layer” refers to a polymeric layer of substantially uniform-thickness.

The layer of electrospun nanofibers is arranged in a nonwoven way. In some embodiments, the layer of electrospun nanofibers comprises a plurality of randomly oriented nanofibers with an aspect ratio greater than 1000:1 (or polymeric nanofibers). In some embodiments, the layer of electrospun nanofibers is in the form of a non-oriented or non-aligned matrix comprising a plurality of randomly distributed nanofibers. In some embodiments, the nanofibers are substantially devoid of an alignment or an ordered structure within the layer.

In some embodiments, the overall thickness of the electrospun nanofibers varies between about 500 and about 5000 nm, for example between about 700 nm and about 4000 nm, between about 900 nm and about 3000 nm; it can be about 2000 nm. The thickness of a single layer of electrospun nanofibers may be about between 100 nm and about 300 nm.

According to step d) of the method of the present invention, the nanoparticle photocatalysts are embedded (or encapsulated) in the electrospun nanofibers.

The electrospun nanofibers in the air filtration material are such that they have an average fiber diameter (AFD) of 30 to 300 nm and a length to diameter aspect ratio (DAR) of greater than 1000 to 1. The electrospinning conditions are controlled during step d) to produce electrospun nanofibers with such an AFD and DAR. Nanofibers presenting such an AFD and a DAR have been found to improve the filtration properties of the resultant material when combined with the other features of the air filtration material described herein.

In some embodiments, the electrospun nanofibers in the air filtration material are such that they have an average fiber diameter (AFD) of 40 to 290 nm, 50 to 260 nm, or 60 to 250 nm.

In some embodiments, the electrospun nanofibers in the air filtration material are such that they have a length to diameter aspect ratio (DAR) of greater than 1100 to 1, greater than 1200 to 1, greater than 2000 to 1, or greater than 2500 to 1.

In some preferred embodiments, the electrospun nanofibers present a high porosity or ultra-high porosity in comparison to nanofibers obtained from the electrospinning process of the prior art. The porosity of the electrospun nanofibers results from the process of the present invention, for example the process parameters and/or the use of the focused thermal radiation during step b) and/or the implementation of step e), as defined below. Reference can be made to FIG. 2 which shows a 45% porosity at the surface of the nanofibers, notably where nanoparticles are encapsulated.

In some embodiments, the electrospun nanofibers have a high surface area, that-is-to-say a surface area which is greater than traditional melt blown fibers. For example, the surface area of the electrospun nanofibers of the present invention is one, two, three, four or even five times greater than the one of traditional melt blown fibers.

In some embodiments, the air filtration system has an air flow resistance (pressure drop) of less than 50 Pa at a flow rate of 100/min, as measured using the test method described in EN-1822-3. In these embodiments, the air filtration system may have an air flow resistance of less than 45 Pa.

The air filtration material of the present invention may have a porosity of 30 to 95% for airflow. Such porosity may be formed by interconnected polymeric electrospun nanofibers which are electrospun onto the support. Such porosity, combined with the high surface area of nanofibers is well-suited to efficiently capture pollutants such as microbes or pathogens. Microbes may for example be fungi, insects, bacteria, microorganisms, viruses, including any combination thereof. In some embodiments, pollutants are human pathogens (e.g., human viruses and/or human microorganisms). In some embodiments, pollutants are airborne pathogens.

In some embodiments, the air filtration material of the present invention has a median pore size in a range between 60 and 1000 nm.

Such air filtration system is suitable for capturing pollutants such as microbes.

In some embodiments, the process of the present invention further comprises, simultaneously to step d) and/or after step d), applying focused thermal radiation to the material. Such heating treatment may be advantageous to enable solvent evaporation during step d) of after step d). The evaporation of the solvent during the electrospinning helps to create nanofiber porosity. In these embodiments, a heating device may be used to apply thermal radiation while the electrospun nanofibers are deposited onto the support and/or after they are deposited onto the support. Furthermore, the heating device may contain a sensor for measuring the temperature of the device itself so that the heating can be controlled; alternatively, the heating can also be controlled by other inputs such as by the electrospun nanofibers surface temperature sensor. Both a device sensor and a surface temperature sensor may be used to precisely adjust the temperature applied to the material. The thermal radiation typically heats the electrospun nanofibers surface up to a temperature of 100° C., for example up to 80° C.

The application of focused thermal radiation onto the support during step d) and/or after step d) has been shown to produce an air filtration material with improved performance over existing technologies. Such a step has been shown to improve the exposure of the nanoparticle photocatalysts at the surface of the electrospun nanofibers, by creating nanopores.

In some other embodiments, the process of the present invention further comprises a step e), carried out after step d), of subjecting the material to conditions effective to evaporate the solvent while creating nanopores in the electrospun nanofibers and exposing part of the nanoparticle photocatalysts at the surface of the electrospun nanofibers.

Such further step e) may be carried out after step d) by subjecting the material to a temperature comprised between 20 and 100° C. for at least 5 seconds.

Optional step e) may be carried out while the material is in placed on the collector or after it has been removed from such collector.

In some embodiments, step e) is carried out by subjecting the material to a temperature comprised between 30 and 90° C., between 35 and 85° C., between 40 and 80° C., between 45 and 70° C., or between 50 and 65° C., during at least 5 s, at least 10 s, at least 15 s, at least 20 s, at least 30 s at least 40 s, at least 50 s, at least 1 min or at least 2 min. Subjecting the material to heating after step d) is advantageous to remove (or interchangeably “evaporate” in such embodiments) the solvent at a desired fast rate (which may remain from the polymeric solution), as well as help to create nanopores and expose part of the nanoparticle photocatalysts at the surface of the electrospun nanofibers. In these embodiments, the material may be heated via a heating device. The evaporation of the solvent from particle surface during the electrospinning helps to create nanofiber porosity.

The temperature treatment of the air filtration material according to optional step e) may be in one step or in several steps. For example, distinct temperature ranges may be used to carry out optional step e), for example two or three distinct temperature ranges. For example, the air filtration material may be subjected to a first temperature range of about 35-40° C. for at least 10 s, then to a second higher temperature range of about 60-100° C. for at least 5 s.

In fact, step e) may be advantageous to improve the exposure of the nanoparticle photocatalysts at the surface of the electrospun nanofibers. The exposure of nanoparticle photocatalysts at the surface of nanofibers may be adjusted based on needs, e.g., by controlling the ratio of different (oxide vs metal) nanoparticles and/or selecting appropriate length of hollow orifice as well as the applied electrospun process voltage.

The process control parameters include length of hollow orifice, internal diameter of hollow orifice, distance between orifice and grounded cylinder, applied electrospun process voltage, ratio of polymer to solvent to nanoparticles and temperature application during nanofiber formation and deposition.

In some embodiments, the manufacturing method is such that:
after step b), the support is wrapped around a grounded cylinder; and
during step d), the support is moved in translation while rotating, to collect the electrospun nanofibers from multiple injectors.

In some embodiments, the process of the present invention further comprises a step wherein the support is impregnated with an optional adhesive and/or optional biocide. This optional step may for example take place after step b).

In a second aspect, the present disclosure relates to the air filtration material.

In some embodiments, the air filtration system of the present invention is obtained from the manufacturing method described above. Such air filtration material may be characterized by its porosity (i.e., the presence of nanopores on the electrospun nanofibers) and/or the fact that part of the nanoparticle photocatalysts is exposed at the surface of the electrospun nanofibers, which makes the air filtration of the present invention very efficient as demonstrated in the experimental part. These features derive directly from the process of the present invention.

The air filtration material of the present invention may be characterized by its resistance to air (or resistance to airflow through it). The resistance to air of the material of the present invention can be measured by the pressure drop in inches water gauge (w.g.) or in Pascals (Pa). More precisely, the air filtration material of the present invention may be characterized by its initial resistance, before use, and its resistance after use, when it is loaded with trapped air pollutants.

In some embodiments, the air filtration system has an air flow resistance (pressure drop) of less than 50 Pa at a flow rate of 100/min, as measured using the test method described in EN-1822-3. In these embodiments, the air filtration system may have a resistance of less than 45 Pa.

The air filtration material of the present invention may also be characterized by particle capture efficiency as a function of particle size based on ASHRAE 52.2 test method.

In some embodiments, the air filtration system has a particle capture efficiency of >99.0% at 0.4-0.5 microns particle size. For example, the air filtration system may have a particle capture efficiency of >99.20% at 0.4-0.5 microns particle size, >99.40% at 0.4-0.5 microns particle size or >99.50% at 0.4-0.5 microns particle size.

In some embodiments, the air filtration material, obtainable by the manufacturing process of the present invention, is characterized in that its porosity is from 30 to 95%.

In some embodiments, the air filtration material, obtainable by the manufacturing process of the present invention, is characterized in that the nanoparticle photocatalysts are embedded in the electrospun nanofibers, and part of such nanoparticle photocatalysts is exposed at the surface of the electrospun nanofibers through nanopores.

In some embodiments, the air filtration material comprises:
a porous metallic support which has been treated with at least one chemical agent, having a thickness of 15 to 100 μm;
at least one layer of nonwoven electrospun nanofibers in contact with the support, wherein the electrospun nanofibers have an average diameter of 30-300 nm and a length to diameter aspect ratio of greater than 1000 to 1;
nanoparticle photocatalysts;
wherein the nanoparticle photocatalysts are embedded in the electrospun nanofibers, and part of such nanoparticle photocatalysts is exposed at the surface of the electrospun nanofibers through nanopores.

In some preferred embodiments, the air filtration material is such that:
the support is made of at least one of copper, iron, aluminum and/or silver;
the electrospun nanofibers comprise:
a) poly(methyl methacrylate) (PMMA) and/or polyacrylonitrile (PAN), and
b) encapsulated silver nanoparticle photocatalysts.

The air filtration material of the present invention may be characterized by a porosity of 30 to 95%, as explained above. In some embodiments, the air filtration material of the present invention has a porosity of 40 to 90%, 50 to 85% or 60 to 80%.

In some other embodiments, the air filtration material of the present invention has a median pore size in a range between 60 and 1000 nm, for example about 300 nm. The median pore size of the material of the present invention may be measured by air flow resistance and particle capture efficiency. In some embodiments, the air filtration system of the present invention further comprises at least one adhesive and/or at least one biocide.

In some embodiments, the air filtration system, the support and/or the nanofibers are impregnated with the optional adhesive and/or biocide. In some embodiments, the adhesive and/or biocide is/are embedded on top and/or within the nanofibers. In some embodiments, the adhesive and/or biocide is/are dispersed within the nanofibers. In some embodiments, the adhesive and/or biocide is/are at least partially located within the pores of the material. According to some embodiments, the adhesive and/or biocide is/are homogeneously dispersed within the material. In some embodiments, the adhesive and/or biocide is/are in the form of a layer, for example a uniform layer.

In some embodiments, the air filtration system of the present invention is free of adhesive and/or biocide.

In a third aspect, the present disclosure relates to an air filtration device, comprising:
the air filtration material of the present invention;
a UV LED;
a power source.

In a fourth aspect, the present disclosure relates to a method of using the air filtration material of the present invention. Such method of using comprises:
a) passing an air flow through the air filtration material, wherein the air flow has a pollutant content before passing through the material, in order to decrease the air pollutant content (including its pathogen/microbe overall content); and
b) optionally washing the air filtration material for reuse.

In some embodiments, the air filtration material is exposed to conditions effective to activate nanoparticle photocatalysts before step a), during step a), and/or after step a). The nanoparticle photocatalysts inactivate or kill the pathogens when the device is in operation.

In some embodiments, the nanoparticle photocatalysts activation is carried out by:
exposing the material to UV-A light radiation; and/or
applying electricity to the material.

In some embodiments, the step of washing the air filtration material for reuse is carried out with a detergent, alcohol, hydrogen peroxide, or a basic solution.

According to the present invention, the air filtration material is used in filters for automotive, public transportation, aircraft, air-conditioning, heating system, animal farm, industrial, groceries, hospitals, in personal equipment for military and health purposes, in window or door screens.

### EXAMPLES

### Example 1

The following raw materials were used to prepare the air filtration material #1:
woven copper support, from TWP Inc
NaOH, APS solution and DI water, from Sigma-Aldrich
zinc oxide (10 nm) and silver metal (10 nm) nanoparticles, from Sigma-Aldrich
polyacrylonitrile polymer and DMF solvent material, from Sigma-Aldrich.

Treatment of the porous copper support: the process to create surface grown nanowire on support surface includes (1) preparing an aqueous solution in a 60-ml glass bottle by mixing 7.5 ml of NaOH solution (10 mol/L), 1.5 ml of APS solution (1 mol/L) and 21 ml of deionized (DI) water, (2) cleaning copper support 10 min with acetone and rinse with DI water, (3) place clean copper support in the solution and leave at room temperature and ambient pressure for 5 minutes to surface grow copper hydroxide nanowire (CuOH-NW) on support surface, (4) remove the copper support from the solution and rinse with distilled water and ethanol several times, and dry in air, (5) convert CuOH-NW to pure Cu-NW by heating in hydrogen environment at 150° C. for 1H.

FIG. 4 is a SEM of the support after such treatment. The support is characterized by a surface roughness of 500-1000 nm, as measured as per ASME B46.1. The support before such treatment presented a surface roughness of 50 nm.

Preparation of the polymeric solution #1 by mixing the following components:
5 g of polyacrylonitrile polymer,
9 ml of DMF solvent,
0.2 g of silver photocatalyst nanoparticles, and
0.3 g of zinc oxide nanoparticles.

Electrospinning: In order to electrospun the nanofibers onto the support, the polymeric solution #1 was fed in four plastic injectors with 25 mm long hollow metallic orifice having 0.5 mm internal diameter.

The support was cut at the dimensions of the metallic cylinder (20-inch long and 8-inch in diameter), placed and attached to it with paper tape.

As per electrospun process, 18 KeV voltage was applied to the hollow metallic orifice where orifice was kept at a distance of 35 mm from the electrically grounded cylinder. The polymeric solution was then continuously sprayed onto the copper support attached to the cylinder in nanowire form while the support and cylinder was moved in translation at 5 mm/second speed while rotating at 10 RPM, to collect the electrospun nanofibers from the multiple injectors.

The process was stopped when 45 layers of nanowire deposited on the support.

The air filtration material was then exposed to 50° C. hot air for 30 seconds, while the support is translating and rotating.

Results: Pressure drop was measured using the test method described in EN-1822-3.

TABLE 1

| | Velocity | Resistance | Resistance |
|---|---|---|---|
| % | (FPM/cm · s⁻¹) | (WG) | (Pa) |
| 25 | 2.6/1.3 | 0.010 | 2.5 |
| 50 | 5.3/2.7 | 0.015 | 3.7 |
| 75 | 7.9/4.0 | 0.020 | 5.0 |
| 100 | 10.5/5.3 | 0.030 | 7.5 |
| 125 | 13.1/6.7 | 0.035 | 8.7 |
| 150 | 15.8/8.0 | 0.040 | 10.0 |

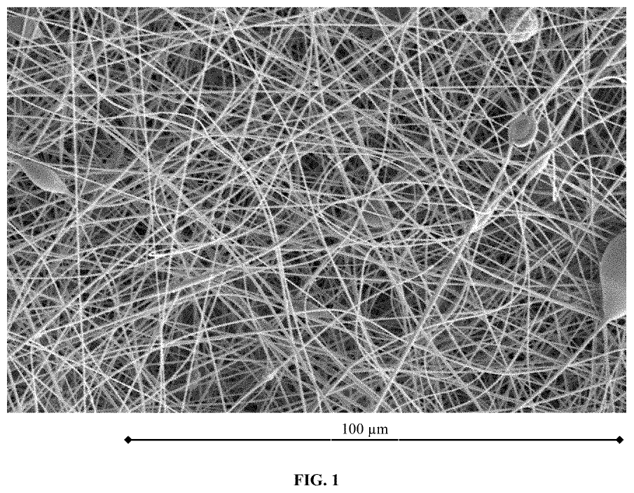

FIG. 1 shows nanoparticles of zinc oxide attached to electrospun nanofibers.

FIG. 2 shows one nanoparticle of silver encapsulated within the electrospun nanofiber. The high porosity was created by the controlled solvent evaporation as detailed above, allowing exposure of encapsulated/embedded nanoparticles. The porosity at the surface of the nanofibers is measured to be 45%.

FIG. 3 shows the porosity of such encapsulated silver particles in greater detail.

### Example 2

The following raw materials were used to prepare the air filtration material #2:
woven steel support, from TWP Inc
acetic acid and DI water, from Amazon Inc
titanium oxide (10 nm) and copper metal (10 nm) nanoparticles, from Sigma-Aldrich
poly(methyl methacrylate) polymer, tetrahydrofuran (THF) and acetone, from Sigma Aldrich.

Treatment of the woven steel support: the process to treat the porous copper support includes (1) cleaning the copper support in water, (2) leave clean copper support in acetic acid for 3 minutes to etch the support surface and (3) rinse clean in water and air dry.

Preparation of the polymeric solution #2 by mixing the following components:
10 g of poly(methyl methacrylate) polymer,
11 ml of THF,
11 ml of acetone (solvent),
0.5 g of copper photocatalyst nanoparticles and
0.5 g of titanium oxide nanoparticles.

Electrospinning: In order to electrospun the nanofibers onto the support, the polymeric solution #2 was fed in four plastic injectors with 35 mm long hollow metallic orifice having 0.8 mm internal diameter.

The support was cut at the dimensions of the metallic cylinder (20-inch long and 8-inch in diameter), placed and attached to it with paper tape.

As per electrospun process, 30 KeV voltage was applied to the hollow metallic orifice where orifice was kept at a distance of 45 mm from the electrically grounded cylinder. The polymeric solution was then continuously sprayed onto the copper support attached to the cylinder in nanowire form, while the support and cylinder was moved in translation at 5 mm/second speed while rotating at 10 RPM, to collect the electrospun nanofibers from the multiple injectors.

The process was stopped when 30 layers of nanowire were deposited on the support.

The material was then exposed to UV light for 3 minutes and removed from the cylinder.

Results: Particle capture efficiency as a function of particle size was measured based on ASHRAE 52.2 test method with the following conditions: air flow rate of 10.5 FPM, 20.6° C., 50% relative humidity, 100.47 kPa.

TABLE 2

| Particle Size | Particle | Particle Capture |
|---|---|---|
| Range (μm) | Mean size (μm) | Efficiency (%) |
| 0.30-0.40 | 0.346 | 99.856 |
| 0.40-0.55 | 0.469 | 99.958 |
| 0.55-0.70 | 0.620 | 99.997 |
| 0.70-1.00 | 0.837 | 100.000 |
| 1.00-1.30 | 1.140 | 100.000 |
| 1.30-1.60 | 1.442 | 100.000 |
| 1.60-2.20 | 1.876 | 100.000 |
| 2.20-3.00 | 2.569 | 100.000 |
| 3.00-4.00 | 3.464 | 100.000 |
| 4.00-5.50 | 4.690 | 100.000 |
| 5.50-7.00 | 6.205 | 100.000 |
| 7.00-10.0 | 8.367 | 100.000 |

### Example 3

The air filtration material #3 was prepared using the same equipment, process and material used to prepare the air filtration material #2, except that simultaneously to the electrospinning of the polymeric solution #3, focused thermal radiation in the form of UV lamps and hot air were applied onto the support to enable solvent evaporation.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A method for manufacturing an air filtration material, comprising:
a) providing a porous metallic support having a thickness of 15 to 100 μm;
b) treating the support with at least one chemical agent;
c) providing a polymeric solution comprising a (co)polymer, a solvent and nanoparticle photocatalysts; and
d) electrospinning the polymeric solution onto the support to generate a material with at least one nonwoven layer of electrospun nanofibers in contact with the support, wherein the nanoparticle photocatalysts are embedded in the electrospun nanofibers,
wherein the electrospun nanofibers in the air filtration material have an average diameter of about 30 to 300 nm and a length to diameter aspect ratio of greater than 1000 to 1.

2. The method of claim 1, wherein the air filtration system has:
an air flow resistance (pressure drop) of less than 50 Pa at a flow rate of 100/min, as measured using the test method described in EN-1822-3, and/or
a particle capture efficiency of >99.0% at 0.4-0.5 μm particle size, as measured using the test method described in ASHRAE 52.2 test method.

3. The method of claim 1, wherein the support is at least partly made of, or coated with, steel, copper, iron, aluminum and/or silver.

4. The method of claim 1, wherein the chemical agent comprises at least one of iron chloride, sodium hydroxide, ammonium persulfate and/or citric acid.

5. The method of claim 1, further comprising simultaneously to step d) and/or after step d), applying focused thermal radiation to the material.

6. The method of claim 1, further comprising:
e) subjecting the material to conditions effective to evaporate the solvent while creating nanopores in the electrospun nanofibers and exposing part of the nanoparticle photocatalysts at the surface of the electrospun nanofibers.

7. The method of claim 6, wherein step e) is carried out by subjecting the material to a temperature comprised between 20 and 100° C. for at least 5 seconds.

8. The method of claim 1, wherein:
after step b), the porous support is wrapped around a grounded metallic cylinder; and
during step d), the support is moved in translation while rotating, to collect the electrospun nanofibers from multiple injectors.

9. The method of claim 1, wherein the (co)polymer comprises recurring units of at least one of poly-L-lactic acid (PLLA), polycaprolactone (PCL), polystyrene (PS), polyamide (PA), polysulfone, polyacrylic acid (PAA), polymethacrylic acid (PMA), polycarbonate (PC), cellulose acetate butyrate (CAB), glycol-modified polyethylene terephthalate (PETG), poly(methyl methacrylate) (PMMA) or polyacrylonitrile (PAN).

10. The method of claim 1, wherein the solvent comprises at least one of water (e.g., deionized water), N,N-dimethylformamide (DMF), formic acid, dichloromethane, acetic acid, chlorophenol, hexafluoroisopropanol, or trifluoroacetic acid.

11. The method of claim 1, wherein the nanoparticle photocatalysts comprise at least one of titanium oxide, copper (oxide), stannic oxide, zinc oxide, vanadium oxide, dibismuth trioxide, tungsten trioxide, ferric oxide, strontium titanate, cadmium sulfide, zirconium oxide, antimony oxide, or cerium oxide.

12. The method of claim 1, wherein the nanoparticle photocatalysts have an average size of 5 to 200 nm.

13. The method of claim 1, wherein the polymeric solution comprises:
1 to 80 wt. % of (co)polymer;
1 to 20 wt. % of solvent;
1 to 70 wt. % of nanoparticle photocatalysts,
based on the total weight of the polymeric solution.

14. An air filtration material, comprising:
a porous metallic support which has been treated with at least one chemical agent, having a thickness of 15 to 100 μm;
at least one layer of nonwoven electrospun nanofibers in contact with the support, wherein the electrospun nanofibers have an average diameter of about 30 to 300 nm and a length to diameter aspect ratio of greater than 1000 to 1;
nanoparticle photocatalysts;
wherein the nanoparticle photocatalysts are embedded in the electrospun nanofibers, and part of such nanoparticle photocatalysts is exposed at the surface of the electrospun nanofibers through nanopores.

15. The air filtration material of claim 14, wherein:
the support is made of at least one of copper, iron, aluminum and/or silver;
the electrospun nanofibers comprise:
a) poly(methyl methacrylate) (PMMA) and/or polyacrylonitrile (PAN), and
b) encapsulated silver nanoparticle photocatalysts.

16. An air filtration device, comprising:
the air filtration material of claim 14 or 15;
a UV LED; and
a power source.

17. A method of using the air filtration material of claim 15, comprising
a) passing an air flow through the air filtration material, wherein the air flow has a pollutant content before passing through the material, in order to decrease the air pollutant content;
b) optionally washing the air filtration material for reuse.

18. The method of claim 17, wherein the air filtration material is exposed to conditions effective to activate nanoparticle photocatalysts before step a), during step a), and/or after step a).

19. The method of claim 18, wherein the nanoparticle photocatalysts activation is carried out by:
exposing the material to UV-A light radiation; and/or
applying electricity to the material.

20. The method of claim 17, wherein step b) is carried out with a detergent, alcohol, hydrogen peroxide, or a basic solution.

21. The method of claim 17, wherein the air filtration material is used in filters for automotive, public transportation, aircraft, air-conditioning, heating system, animal farm, industrial, groceries, hospitals, in personal equipment for military and health purposes, in window or door screens.
